(19) United States
(12) Patent Application Publication
(10) Pub. No.: US 2022/0404001 A1
(43) Pub. Date: Dec. 22, 2022

(54) LAMP HOLDER WITH IMPROVED STRUCTURE

(71) Applicant: XINJIANG ZOU, Meizhou (CN)

(72) Inventor: XINJIANG ZOU, Meizhou (CN)

(21) Appl. No.: 17/352,354

(22) Filed: Jun. 21, 2021

(51) Int. Cl. F21V 19/00; H01R 33/06; H01R 4/2407

(52) U.S. Cl. CPC F21V 19/0005; H01R 33/06; H01R 4/2407

(57) ABSTRACT

The utility model discloses a lamp holder with an improved structure. A lamp holder housing of the lamp holder comprises a housing main body and a housing top cap; a main body mounting hole with a downward opening is formed in the housing main body, and a main body wire clamping groove is formed in the position. Through the structural design, a lamp holder with an improved structure disclosed by the utility model has the advantages of being novel in design, simple in structure, and low in manufacturing cost, and the product cost of the luminaire can be effectively reduced.

### TECHNICAL FIELD

The invention relates to the technical field of lamp holders, and in particular to a lamp holder with an improved structure.

### BACKGROUND

Lighting and power connection of a bulb are achieved through a lamp holder, two conductive terminals are mounted in the lamp holder, and each conductive terminal is electrically connected with an electric wire. When the bulb is mounted on the lamp holder, the bulb needs to be electrically connected with the conductive terminals through a brass head. For bulbs with brass heads, the manufacturing cost of the entire luminaire can be increased.

Furthermore, for an existing lamp holder, two times of injection molding are involved in the machining process thereof, one injection molding procedure is that the conductive terminal is fixed through injection molding, and the other injection molding procedure is that a top cap is formed in the lamp holder through the injection molding; and for the above lamp holder structure, the defects of complex manufacturing process and high manufacturing cost are existent.

### SUMMARY

The utility model aims to provide a lamp holder with an improved structure for the disadvantages of the prior art. The lamp holder with the improved structure is novel in design, simple in structure, low in manufacturing cost, and capable of effectively of reducing the production cost of the luminaire.

To achieve the purpose, the utility model is achieved through the following technical solutions.

A lamp holder with an improved structure comprises a lamp holder housing, wherein the lamp holder housing comprises a housing main body, and a housing top cap arranged at an upper end portion of the housing main body; and the housing main body and the housing top cap are respectively hard plastic parts;
a main body mounting hole with a downward opening is formed in the housing main body, and a main body wire clamping groove which is provided with an upward opening and is completely through left and right is arranged at the position, above the main body mounting hole, of the upper end portion of the housing main body, and the main body wire clamping groove and the main body mounting hole are arranged in a spaced manner; and a top cap wire clamping portion which protrudes downwards and is inserted into the main body wire clamping groove of the housing main body is arranged at the housing top cap;
two terminal mounting holes which are arranged at left and right in a spaced manner and are respectively communicated with the main body mounting hole are formed in the bottom surface of the main body wire clamping groove, and an intermediate connecting terminal is embedded in each terminal mounting hole;
each intermediate connecting terminal comprises a sheet-shaped portion which is sheet-shaped and vertically arranged, and a circular tube portion which is arranged at the edge of the lower end of the sheet-shaped portion and vertically extends downwards; an inserting hole which is provided with a downward opening and is used for the insertion of a PIN of a bulb is formed in a core portion of the circular tube portion, the upper end portion of the sheet-shaped portion is provided with a pointed piercing portion which protrudes upwards and extends, and the pointed piercing portion protrudes out of the bottom surface of the main body wire clamping groove; and the sheet-shaped portion, the circular tube portion and the pointed piercing portion are of an integrated structure.

Wherein each terminal mounting hole comprises a sheet-shaped limiting portion which is consistent with the sheet-shaped portion of the intermediate connecting terminal in shape, and a circular tube limiting portion which is consistent with the circular tube portion of the intermediate connecting terminal in shape.

Wherein a main body internal thread in screw joint with a screw-socket bulb cover is arranged on an inner wall of the main body mounting hole; or a buckle clamped with a bayonet-socket bulb cover is arranged on the inner wall of the main body mounting hole.

Wherein two top cap buckle tongues which protrude downwards and extend respectively are arranged at the housing top cap, each top cap buckle tongue and the housing top cap are of an integrated structure, and the two top cap buckle tongues are arranged in a spaced and opposite manner;
and main body buckle holes corresponding to the top cap buckle tongues are respectively formed in the housing main body, and each top cap buckle tongue is buckled in the corresponding main body buckle hole.

Wherein the top cap wire clamping portion and the housing top cap are of an integrated structure.

Wherein wire limiting grooves are formed in the lower surface of the top cap wire clamping portion.

Wherein a fixed lifting ring is arranged at the upper surface of the housing top cap, and the fixed lifting ring and the housing top cap are of an integrated structure.

Wherein a fixed pothook is arranged at an edge portion of the housing top cap.

Wherein the intermediate connecting terminal is a metal terminal.

The utility model has the beneficial effects as follows: a lamp holder with an improved structure disclosed by the utility model comprises a lamp holder housing, wherein the lamp holder housing comprises a housing main body, and a housing top cap arranged at an upper end portion of the housing main body; the housing main body and the housing top cap are respectively hard plastic parts; a main body mounting hole with a downward opening is formed in the housing main body, a main body wire clamping groove which is provided with an upward opening and is completely through left and right is arranged at the position, above the main body mounting hole, of the upper end portion of the housing main body, and the main body wire clamping groove and the main body mounting hole are arranged in a spaced manner; a top cap wire clamping portion which protrudes downwards and is inserted into the main body wire clamping groove of the housing main body is arranged at the housing top cap; two terminal mounting holes which are arranged at left and right in a spaced manner and are respectively communicated with the main body mounting hole are formed in the bottom surface of the main body wire clamping groove, and an intermediate connecting terminal is embedded in each terminal mounting hole; each intermediate connecting terminal comprises a sheet-shaped portion which is sheet-shaped and vertically arranged, and a circular tube portion which is arranged at the edge of the lower end of the sheet-shaped portion and vertically extends downwards; an inserting hole which is provided with a downward opening and is used for the insertion of a PIN of a bulb is formed in a core portion of the circular tube portion, the upper end portion of the sheet-shaped portion is provided with a pointed piercing portion which protrudes upwards and extends, and the pointed piercing portion protrudes out of the bottom surface of the main body wire clamping groove; and the sheet-shaped portion, the circular tube portion and the pointed piercing portion are of an integrated structure. Through the above structural design, a lamp holder with an improved structure disclosed by the utility model has the advantages of being novel in design, simple in structure, and low in manufacturing cost, and the production cost of the luminaire can be effectively reduced.

The utility model discloses a lamp holder with an improved structure. A lamp holder housing of the lamp holder comprises a housing main body and a housing top cap; a main body mounting hole with a downward opening is formed in the housing main body, and a main body wire clamping groove is formed in the position, above the main body mounting hole, of an upper end portion of the housing main body; a top cap wire clamping portion is arranged at the housing top cap; two terminal mounting holes are formed in the bottom surface of the main body wire clamping groove, and an intermediate connecting terminal is embedded in each terminal mounting hole; each intermediate connecting terminal comprises a sheet-shaped portion which is sheet-shaped and vertically arranged, and a circular tube portion which is arranged at the edge of the lower end of the sheet-shaped portion and vertically extends downwards; an inserting hole which is provided with a downward opening and is used for the insertion of a PIN of a bulb is formed in a core portion of the circular tube portion; and the upper end portion of the sheet-shaped portion is provided with a pointed piercing portion which protrudes upwards and extends, and the pointed piercing portion protrudes out of the bottom surface of the main body wire clamping groove. Through the above structural design, a lamp holder with an improved structure disclosed by the utility model has the advantages of being novel in design, simple in structure, and low in manufacturing cost, and the product cost of the luminaire can be effectively reduced.

### BRIEF DESCRIPTION OF THE DRAWINGS

The utility model is further described below with reference to the accompanying drawings, but the embodiments in the accompanying drawings do not constitute any limitation of the utility model.

FIG. 1 is a structural diagram of an embodiment I of the utility model.

FIG. 2 is a breakdown diagram of an embodiment I of the utility model.

FIG. 3 is a section diagram of an embodiment I of the utility model.

FIG. 4 is a structural diagram of an intermediate connecting terminal of an embodiment I of the utility model.

FIG. 5 is a structural diagram of an embodiment II of the utility model.

FIG. 6 is a structural diagram of an embodiment III of the utility model.

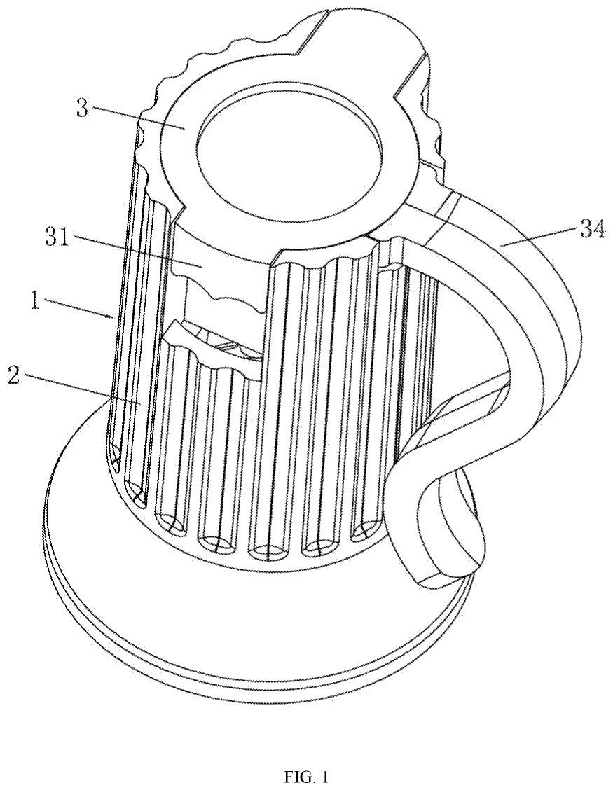

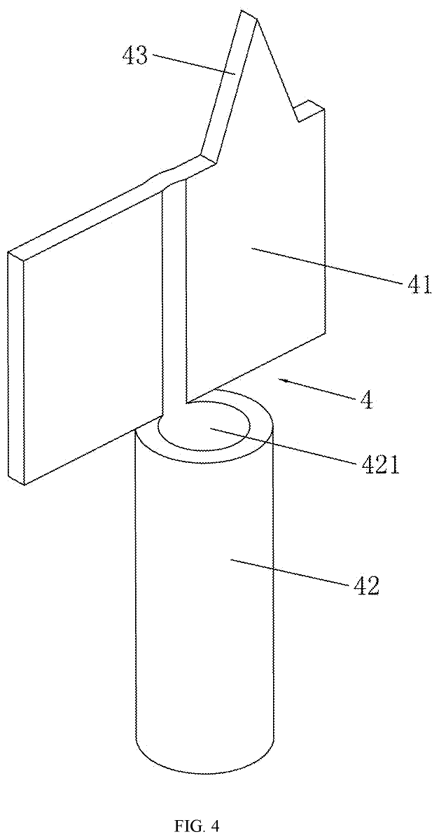

Reference signs in the FIG. 1 to FIG. 6:
1—lamp holder housing, 2—housing main body, 21—main body mounting hole, 22—main body wire clamping groove, 23—terminal mounting hole, 231—sheet-shaped limiting portion, 232—circular tube limiting portion, 24—main body internal thread, 25—main body buckle hole, 3—housing top cap, 31—top cap wire clamping portion, 32—top cap buckle tongue, 33—wire limiting groove, 34—fixed pothook, 4—intermediate connecting terminal, 41—sheet-shaped portion, 42—circular tube portion, 421—inserting hole, 43—pointed piercing portion.

### DESCRIPTION OF THE EMBODIMENTS

The utility model will be described below with reference to the specific embodiments.

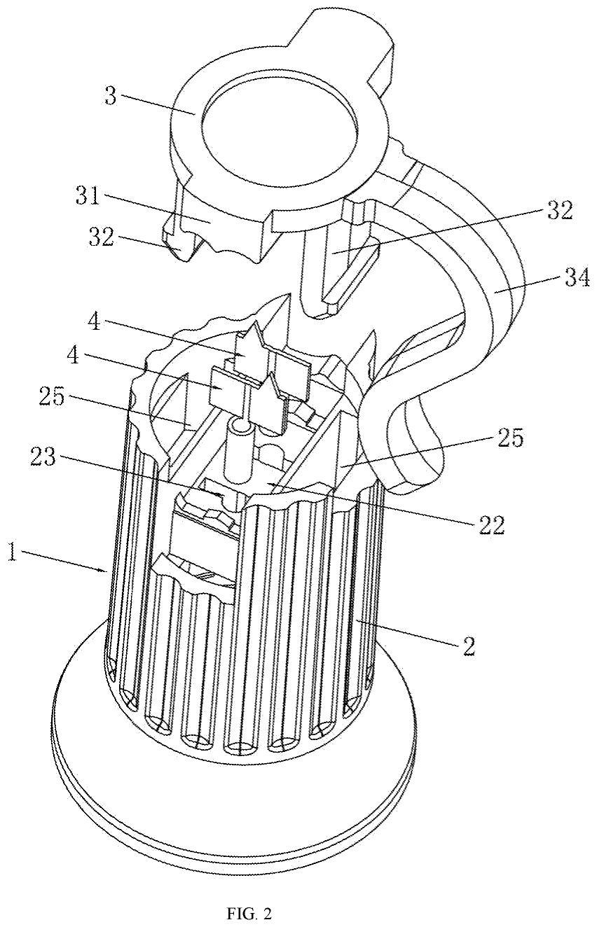

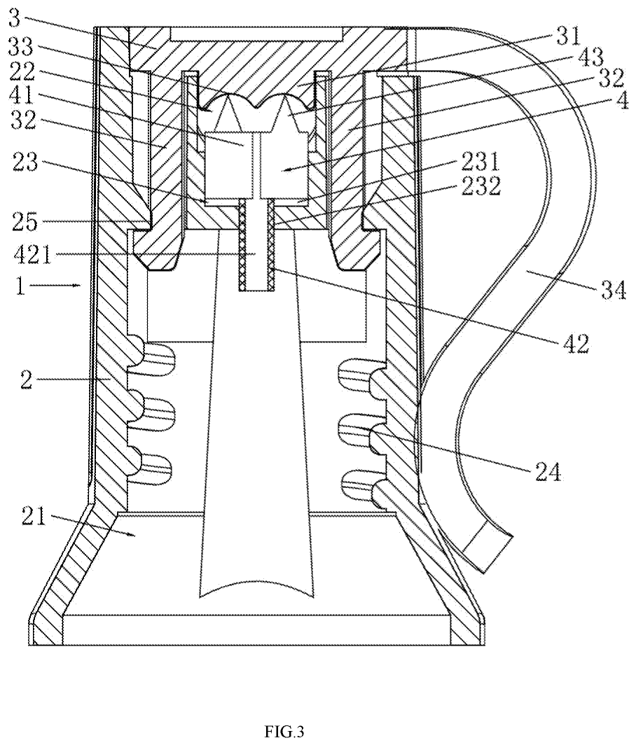

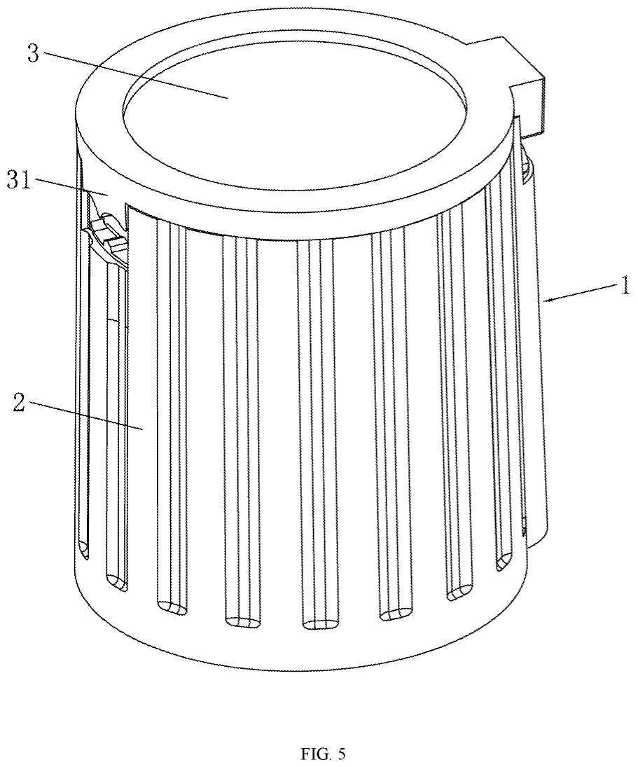

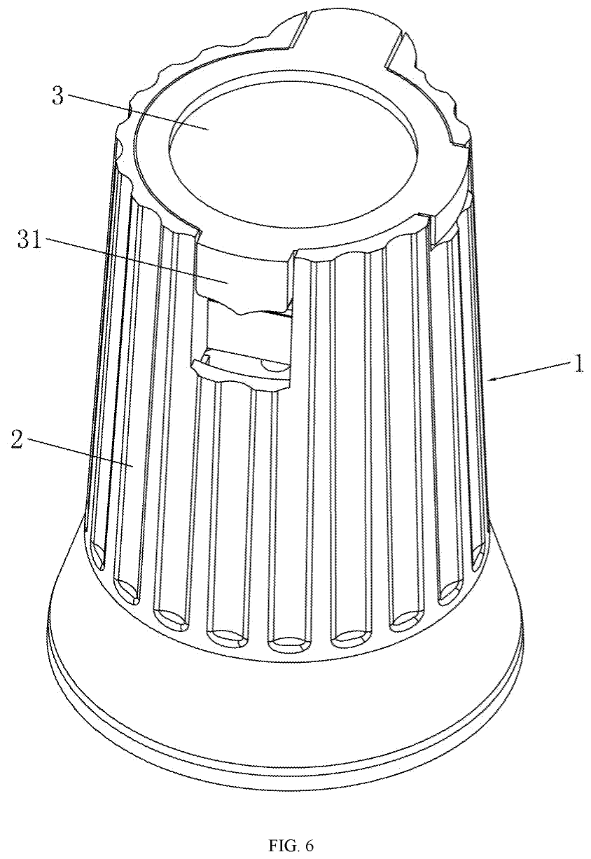

As shown in FIG. 1, FIG. 2, FIG. 3, FIG. 5 and FIG. 6, a lamp holder with an improved structure comprises a lamp holder housing 1, wherein the lamp holder housing 1 comprises a housing main body 2, and a housing top cap 3 arranged at an upper end portion of the housing main body 2; and the housing main body 2 and the housing top cap 3 are respectively hard plastic parts.

Further, as shown in FIG. 2 and FIG. 3, a main body mounting hole 21 with a downward opening is formed in the housing main body 2, a main body wire clamping groove 22 which is provided with an upward opening and is completely through left and right is arranged at the position, above the main body mounting hole 21, of the upper end portion of the housing main body 2, and the main body wire clamping groove 22 and the main body mounting hole 21 are arranged in a spaced manner; and a top cap wire clamping portion 31 which protrudes downwards and is inserted into the main body wire clamping groove 22 of the housing main body 2 is arranged at the housing top cap 3. Preferably, the top cap wire clamping portion 31 and the housing top cap 3 are of an integrated structure.

Further, as shown in FIG. 2 and FIG. 3, two terminal mounting holes 23 which are arranged at left and right in a spaced manner and are respectively communicated with the main body mounting hole 21 are formed in the bottom surface of the main body wire clamping groove 22, and an intermediate connecting terminal 4 is embedded in each terminal mounting hole 23. Preferably, the intermediate connecting terminal 4 is a metal terminal.

In addition, as shown in FIG.2 to FIG. 4, each intermediate connecting terminal 4 comprises a sheet-shaped portion 41 which is sheet-shaped and vertically arranged, and a circular tube portion 42 which is arranged at the edge of the lower end of the sheet-shaped portion 41 and vertically extends downwards; an inserting hole 421 which is provided with a downward opening and is used for the insertion of a PIN of a bulb is formed in a core portion of the circular tube portion 42, the upper end portion of the sheet-shaped portion 41 is provided with a pointed piercing portion 43 which protrudes upwards and extends, and the pointed piercing portion 43 protrudes out of the bottom surface of the main body wire clamping groove 22; and the sheet-shaped portion 41, the circular tube portion 42 and the pointed piercing portion 43 are of an integrated structure.

It needs to be explained that, as shown in FIG. 3, in order to accurately limit the intermediate connecting terminal 4 in the corresponding terminal mounting hole 23, the following shape design is adopted by the terminal mounting hole 23 of the utility model, specifically: the terminal mounting hole 23 comprises a sheet-shaped limiting portion 231 which is consistent with the sheet-shaped portion 41 of the intermediate connecting terminal 4 in shape, and a circular tube limiting portion 232 which is consistent with the circular tube portion 42 of the intermediate connecting terminal 4 in shape.

Furthermore, a main body internal thread 24 in screw joint with a screw-socket bulb cover is arranged at an inner wall of the main body mounting hole 21; or a buckle clamped with a bayonet-socket bulb cover is arranged at the inner wall of the main body mounting hole 21.

In the process of assembling the utility model, two intermediate connecting terminals 4 are sequentially embedded and inserted into the corresponding terminal mounting holes 23, and then two wires are placed in the main body wire clamping groove 22 of the housing main body 2, wherein one wire is aligned with the pointed piercing portion 43 of one intermediate connecting terminal 4, and the other wire is aligned with the pointed piercing portion 43 of the other intermediate connecting terminal 4; after the wires are placed in the main body wire clamping groove 22, the housing top cap 3 is mounted at the upper end portion of the housing main body 2, and the top cap wire clamping portion 31 of the housing top cap 3 is inserted into the main boy wire clamping groove 22; under the pressing action of the top cap wire clamping portion 31, the pointed piercing portion 43 of each intermediate connecting terminal 4 pierces an insulating layer of the corresponding wire, and each intermediate connecting terminal 4 is in electrical contact with a wire core of the corresponding wire, and then the electric conduction between each intermediate connecting terminal 4 and the corresponding wire is achieved.

In addition, in the process of mounting a bulb and a screw-socket bulb cover in the utility model, one PIN of the bulb is inserted into the inserting hole 421 of the circular tube portion 42 of one intermediate connecting terminal 4, and the other PIN of the bulb is inserted into the inserting hole 421 of the circular tube portion 42 of the other intermediate connecting terminal 4; and after the insertion of the PIN of the bulb is finished, the screw-socket bulb cover is screwed into the main body internal thread 24 of the housing main body 2. It should be emphasized that, for the lamp holder disclosed by the utility model, the lamp holder does not need to be connected with the brass head of the bulb, but is directly connected with the PIN of the bulb, that is, the cost of the brass head of the bulb may be saved.

It needs to be further indicated that in the prior art, a terminal assembling technology of the lamp holder comprises the following steps of firstly, pushing an outer covering of an electric wire away, then punching a terminal after the outer covering of the electric wire is pushed away, and placing the terminal-punched outer covering in a die cutting machine for injection molding; wherein the injection molding process is divided into two steps, the first step is the injection molding of a terminal fixing support, and the second step is the injection molding of a top cap. For the intermediate connecting terminal 4 of the utility model, each intermediate connecting terminal 4 of the utility model is mounted in the corresponding terminal mounting hole 23 of the housing main body 2 by adopting a plug-in mounting manner, without injection-molding the terminal, the housing and the electric wire into one by adopting the die cutting machine, and therefore, the manufacturing cost may be effectively reduced.

From the above, through the structural design, the lamp holder disclosed by the utility model has the advantages of being novel in design, simple in structure and low in manufacturing cost, and the production cost of the luminaire can be effectively reduced.

As a preferred embodiment, as shown in FIG. 2 and FIG. 3, the housing top cap 3 of the utility model can be mounted at an upper end portion of the housing main body 2 in a buckle connecting manner, specifically: two top cap buckle tongues 32 which protrude downwards and extend respectively are arranged at the housing top cap 3, each top cap buckle tongue 32 and the housing top cap 3 are of an integrated structure, and two top cap buckle tongues 32 are arranged in a spaced and opposite manner; and main body buckle holes 25 corresponding to the top cap buckle tongues 32 are respectively formed in the housing main body 2, and each top cap buckle tongue 32 is buckled in the corresponding main body buckle hole 25.

As a preferred embodiment, as shown in FIG. 3, in the process of pressing wires by the top cap wire clamping portion 31 of the housing top cap 3, in order to limit the wires so as to guarantee the stability of pressing the wires, the following structural design may be adopted, specifically: two wire limiting grooves 33 which are arranged in a spaced manner are formed in the lower surface of the top cap wire clamping portion 31; when the wires are pressed by the top cap wire clamping portion 31, one wire is limited through one wire limiting groove 33, and the other wire is limited through the other wire limiting groove 33.

As a preferred embodiment, a fixed lifting ring is arranged at the upper surface of the housing top cap 3, and the fixed lifting ring and the housing top cap 3 are of an integrated structure. In the process of mounting, the lamp holder disclosed by the utility model can be lifted at a corresponding mounting position through the fixed lifting ring.

As a preferred embodiment, as shown in FIG. 1 to FIG. 3, a fixed pothook 34 is arranged at an edge portion of the housing top cap 3; and in the process of mounting, the lamp holder disclosed by the utility model can be hung at the corresponding mounting position through the fixed pothook 34.

Above content is a preferred embodiment of the utility model only, and for those of ordinary skill in the art, according to thought of the utility model, all will change in specific embodiments and applications, and this description should not be construed as limitation of the utility model.

What is claimed is:

1. A lamp holder with an improved structure, comprising a lamp holder housing (1), wherein the lamp holder housing (1) comprises a housing main body (2), and a housing top cap (3) arranged on an upper end portion of the housing main body (2); and the housing main body (2) and the housing top cap (3) are respectively hard plastic parts;
a main body mounting hole (21) with a downward opening is formed in the housing main body (2), a main body wire clamping groove (22) which is provided with an upward opening and is completely through left and right is arranged at the position, above the main body mounting hole (21), of the upper end portion of the housing main body (2), and the main body wire clamping groove (22) and the main body mounting hole (21) are arranged in a spaced manner; and a top cap wire clamping portion (31) which protrudes downwards and is inserted into the main body wire clamping groove (22) of the housing main body (2) is arranged at the housing top cap (3);
two terminal mounting holes (23) which are arranged at left and right in a spaced manner and are respectively communicated with the main body mounting hole (21) are formed in the bottom surface of the main body wire clamping groove (22), and an intermediate connecting terminal (4) is embedded in each terminal mounting hole (23);
each intermediate connecting terminal (4) comprises a sheet-shaped portion (41) which is sheet-shaped and vertically arranged, and a circular tube portion (42) which is arranged at the edge of the lower end of the sheet-shaped portion (41) and vertically extends downwards; an inserting hole (421) which is provided with a downward opening and is used for the insertion of a PIN of a bulb is formed in a core portion of the circular tube portion (42); the upper end portion of the sheet-shaped portion (41) is provided with a pointed piercing portion (43) which protrudes upwards and extends, and the pointed piercing portion (43) protrudes out of the bottom surface of the main body wire clamping groove (22); and the sheet-shaped portion (41), the circular tube portion (42) and the pointed piercing portion (43) are of an integrated structure.

2. The lamp holder with the improved structure according to claim 1, wherein each terminal mounting hole (23) comprises a sheet-shaped limiting portion (231) which is consistent with the sheet-shaped portion (41) of the intermediate connecting terminal (4) in shape, and a circular tube limiting portion (232) which is consistent with the circular tube portion (42) of the intermediate connecting terminal (4) in shape.

3. The lamp holder with the improved structure according to claim 1, wherein a main body internal thread (24) in screw joint with a screw-socket bulb cover is arranged at an inner wall of the main body mounting hole (21); or a buckle clamped with a bayonet-socket bulb cover is arranged at the inner wall of the main body mounting hole (21).

4. The lamp holder with the improved structure according to claim 1, wherein two top cap buckle tongues (32) which protrude downwards and extend respectively are arranged at the housing top cap (3), each top cap buckle tongue (32) and the housing top cap (3) are of an integrated structure, and the two top cap buckle tongues (32) are arranged in a spaced and opposite manner;
and main body buckle holes (25) corresponding to the top cap buckle tongues (32) are respectively formed in the housing main body (2), and each top cap buckle tongue (32) is buckled in the corresponding main body buckle hole (25).

5. The lamp holder with the improved structure according to claim 1, wherein the top cap wire clamping portion (31) and the housing top cap (3) are of an integrated structure.

6. The lamp holder with the improved structure according to claim 1, wherein wire limiting grooves (33) are formed in the lower surface of the top cap wire clamping portion (31).

7. The lamp holder with the improved structure according to claim 1, wherein a fixed lifting ring is arranged at the upper surface of the housing top cap (3), and the fixed lifting ring and the housing top cap (3) are of an integrated structure.

8. The lamp holder with the improved structure according to claim 1, wherein a fixed pothook (34) is arranged at an edge portion of the housing top cap (3).

9. The lamp holder with the improved structure according to claim 1, wherein the intermediate connecting terminal (4) is a metal terminal.
